(19) United States
(12) Patent Application Publication
(10) Pub. No.: US 2023/0367027 A1
(43) Pub. Date: Nov. 16, 2023

(54) METHOD FOR COMBINED UP-DOWN WAVEFIELD SEPARATION AND REDUCING NOISE IN VERTICAL PARTICLE MOTION MEASUREMENTS USING JOINT SPARSITY RECOVERY

(71) Applicant: DUG Technology (Australia) Pty Ltd., West Perth (AU)

(72) Inventors: Gary Hampson, Peppermint Cove (AU); Amarjeet Kumar, West Perth (AU); Tom Rayment, Bexley (GB)

(21) Appl. No.: 18/220,237

(22) Filed: Jul. 10, 2023

Related U.S. Application Data
(63) Continuation of application No. PCT/US2021/073159, filed on Dec. 29, 2021.
(60) Provisional application No. 63/137,897, filed on Jan. 15, 2021.
(60) Provisional application No. 63/189,900, filed on May 18, 2021.

(51) Int. Cl. G01V 1/36; G01V 1/38; G01V 1/30

(52) U.S. Cl. CPC G01V 1/364; G01V 1/3808; G01V 1/303; G01V 2210/56

(57) ABSTRACT

A method for estimating noise in particle motion seismic recordings and upgoing (deghosted) and downgoing components of ecorded wavefields includes inputting pressure related and particle motion related seismic signals. A sparsity promoting transformation is applied to the input seismic signals. A matrix Ã and column vector \tilde{b} are constructed according to the expression:

$$\tilde{A} = ( \begin{matrix}I & I & 0 \\ I & - I & λ I\end{matrix} ) \qquad \tilde{x} = ( \begin{matrix}d \\ u \\ n\end{matrix} ) \qquad \tilde{b} = ( \begin{matrix}{A}^{- 1} p \\ {A}^{- 1} z\end{matrix} ) ,$$

wherein d represents a down-going seismic wavefield, u represents an up-going seismic wavefield, n represents the noise and λ represents a user-chosen scalar to adjust emphasis of the noise. A constrained minimization is solved according to the expression

$$\begin{matrix}\tilde{x} = arg min μ {‖ \tilde{x} ‖}_{1} + \frac{1}{2} {‖ \tilde{x} ‖}_{2}^{2} & st & \tilde{A} \tilde{x}\end{matrix} = \tilde{b}$$

for \tilde{x}; wherein μ represents a user-chosen scalar to adjust relative importance of minimization norms. The solved constrained minimization is inverse transformed and reordered back into a domain of the input seismic signals. An output is generated comprising an estimate of the noise contained in the particle motion recording, the downgoing wavefield and the upgoing (deghosted) wavefield.

### CROSS REFERENCE TO RELATED APPLICATIONS

Continuation of International Application No. PCT/US2021/073159 filed on Dec. 29, 2021. Priority is claimed from U.S. Provisional Application No. 63/137,897 filed on Jan. 15, 2021 and U.S. Provisional Application No. 63/189,900 filed on May 18, 2021. Each of the three foregoing applications is incorporated herein by reference in its entirety.

### STATEMENT REGARDING FEDERALLY SPONSORED RESEARCH OR DEVELOPMENT

Not Applicable

### NAMES OF THE PARTIES TO A JOINT RESEARCH AGREEMENT

Not Applicable.

### BACKGROUND

This disclosure relates to the field of marine seismic surveying using sensors deployed in, or at the base of, the water column. More specifically, this disclosure relates to methods for reducing noise, separating a wavefield into up-going and down-going waves and removing the effects of seismic energy reflections from the water surface, such removal called “deghosting.”

It is known in the art to acquire seismic exploration data with a plurality of sensors, receivers or detectors (used interchangeably in this disclosure) placed in, or at the base of, the water column of a body of water. The detectors may, for example, be distributed along a cable or streamer being towed along through the water by a vessel. In a second example the sensors may be placed at the base of the water-column. One or more seismic energy sources may be actuated in the water, from which seismic energy propagates outwardly. Some of the seismic energy propagates through the water bottom and into earthen formations below, whereupon some of the energy may be reflected from various features in the formations, and propagate back upwardly toward the detectors. The detectors typically sense both pressure or its time derivative, e.g., using hydrophones, and particle motion (velocity or acceleration) using geophones or accelerometers. The particle motion sensors may be single component (measurement in only one direction) or multiple component. In one method of processing data acquired using such detectors, the pressure and particle motion measurements can be linearly combined to separate the detected seismic wavefield into up-going and down-going waves. Upgoing waves are detected by the sensors and then continue upwards until reaching the free (water) surface, where they are reflected, and are detected again by the sensors as part of the downgoing wavefield. The energy of this second detection, known as the (receiver) ghost, follows the detection of the upgoing wave after a time proportional to the detector depth below the water surface. Since the receiver ghost is absent from the upgoing wavefield, wavefield separation provides a method to remove the receiver ghost. Methods that remove ghosts are known in the art as deghosting. Deghosting that uses more than one sensor type is sometimes called dual-component or multi-component deghosting. The presence of the receiver ghost limits the resolution of the seismic wavefield by modulating the spectrum of the measured pressure and particle motion fields. Deghosting removes the spectral modulations, which significantly restores the resolving power of the wavefield to that of an un-ghosted state.

However, the foregoing and other deghosting processing methods only work well if the input data to the process is reasonably uncontaminated by noise. The cables or streamers, which carry the various sensors and are towed through the water, suffer from vibrations and flow noises caused by fluid turbulence. Certain mitigations to reduce the effects of this noise are known in the art. One such method combines the outputs of a plurality of spaced apart sensors (sometimes known as group forming) to enhance the common signals and attenuate the noise. Another method which can only be applied to the pressure or pressure time derivative sensors is to configure pairs of such pressure or pressure time derivative sensors to cancel the effects of particle accelerations (known in the art as acceleration cancelling hydrophones). Using such sensors renders the pressure or pressure time derivative measurements relatively free from noise. However, in contrast, particle motion sensors are required by their very purpose to respond to accelerations. As a result, particle motion sensor data are often strongly contaminated with noise due to turbulent flow and vibrations. This noise is usually most noticeable at frequencies below, about 25 Hz. FIG. 1A illustrates a seismic shot record recorded with a streamer of hydrophones in which the coherent events in the wavefield are apparent. FIG. 1B shows the same recording made with collocated vertical particle velocity sensors. It shows clearly the severity of the noise problem obscuring the coherent events of interest. This problem is widely appreciated in the art and many efforts have been made to deal with this noise in order to exploit the benefits of wavefield separation. In one method, disclosed in by Sollner in US Pat. App. Pub. No. 2011/0063948A1, wavefield separation by linear combination of the pressure and particle motion data is used at the higher less-noisy frequencies, whereas at the lower noisier frequencies, what amounts to pressure-only deghosting (by deconvolution) is performed. Then the two results are merged to provide one deghosted result. This means that the particle motion data does not contribute to the wavefield separation at the lower noisier frequencies. In other methods, mixtures of two or more conventional noise attenuation techniques are employed. An advantage of pure dual-component deghosting by linear combination is that it does not require knowledge of the free-surface reflectivity function, the shape of the free-surface, the receiver depth or the water velocity. In the case that the sensors are placed at the base of the water-column, the sensors are in contact with a solid substrate. In this case the pressure sensors detect the pressure waves in the water body, whereas the particle motion sensors detect the motion of the surface of the substrate. As a consequence the particle velocity sensors not only detect pressure waves, but also shear waves and rotational waves such as Scholte waves. This means that in the absence of other noise sources, the simple linear combination of pressure and particle motion measurements is no longer adequate to separate the wavefield into up-going and down-going waves; such linear combination therefore can no-longer correctly deghost the wavefield. Such noise is often termed “Vz-noise” because of its presence in the detected signals of vertically oriented particle motion sensors, (e.g., geophones and accelerometers). Such noise is thought to be caused by seismic source (shot) energy scattering off water bottom (sea-floor) heterogeneities and propagating as interface waves (so called Scholte waves) along the water bottom (see, Paffenholz et al., 2006b). A model of a cross-section through the Earth showing such heterogeneities is shown in FIG. 2 which is similar to the model used in Paffenholz et al., (2006a).

Synthetic seismic data, generated using the Earth model shown in FIG. 2 is shown in FIGS. 3A through 3D. The Vz-noise is weak or absent from the pressure (e.g., hydrophone) data because shear waves do not propagate in the water and as a result the pressure sensors (hydrophones) do not detect shear motion. However, as the synthetic data shows in FIGS. 3B and 3D, Vz-noise is often strong enough in the vertical particle velocity data that it requires removal before either wavefield separation or PZ summation can take place (see, e.g., Craft and Paffenholz, 2007; Hampson and Szumski, 2020). The strength of the Vz-noise depends on the heterogeneities present in the water bottom sediments. The Scholte wave propagation velocity in such sediments is extremely low, e.g., around 90% of the sediment shear wave velocity. As a result, Vz-noise is spatially aliased and is apparently unpredictable even between particle motion sensors spaced only a few metres apart (see FIG. 3D). The domain in which the Vz-noise is least likely to be spatially aliased is the common-receiver domain.

Various methods have been proposed to remove Vz-noise from water bottom particle motion (e.g., geophone) data. An example of such method is disclosed in Craft & Paffenholz (2007), and is also described in U.S. Pat. No. 7,953,556 issued to Craft et al. The disclosed example method works by shaping the frequency dependent envelope of filtered geophone traces to match those of the hydrophone traces.

From the foregoing it is evident that, in the context of detectors situated in, or at the base of, the water column, there is a need for improved methods of performing up/down wavefield separation that have reduced sensitivity to noise in the recorded particle motion wavefields.

### SUMMARY

One aspect of the present disclosure relates to methods for attenuating noise in seismic data. A method according to this aspect of the disclosure for attenuating noise in particle motion seismic sensor recordings includes inputting to a computer, seismic signals comprising pressure related signals and particle motion related signals. A sparsity promoting transformation is applied to the input seismic signals in the computer. A matrix Ã and column vector \tilde{b} are constructed in the computer according to the expression:

$$\tilde{A} = ( \begin{matrix}I & I & 0 \\ I & - I & λ I\end{matrix} ) \qquad \tilde{x} = ( \begin{matrix}d \\ u \\ n\end{matrix} ) \qquad \tilde{b} = ( \begin{matrix}{A}^{- 1} p \\ {A}^{- 1} z\end{matrix} ) ,$$

wherein d represents a down-going seismic wavefield, u represents an up-going seismic wavefield, n represents the noise and λ represents a user-chosen scalar to adjust emphasis of the noise. A constrained minimization is solved in the computer according to the expression

$$\begin{matrix}\tilde{x} = arg min μ {‖ \tilde{x} ‖}_{1} + \frac{1}{2} {‖ \tilde{x} ‖}_{2}^{2} & st & \tilde{A} \tilde{x}\end{matrix} = \tilde{b}$$

for \tilde{x}; wherein μ represents a user-chosen scalar to adjust relative importance of minimization norms. The solved constrained minimization is inverse transformed in the computer and reordered back into a domain of the input seismic signals. An output is generated by the computer comprising one or more of an estimate of the noise in the particle motion wavefield, an estimate of the down-going pressure wavefield and an estimate of the upgoing (deghosted) pressure wavefield.

A method for seismic surveying according to another aspect of this disclosure includes, at selected times, actuating a seismic energy source in a body of water. Seismic signals are detected at a plurality of spaced apart locations in, or at the base of, the body of water. The signals comprise pressure related signals and particle motion, related partly in response to actuation of the seismic energy source and partly in response to noise comprising one or more of unwanted vibrations, turbulence and Vz-noise. The signals are conducted to a computer. A sparsity promoting transformation is applied to the input seismic signals in the computer. A matrix Ã and column vector \tilde{b} are constructed in the computer according to the expression:

$$\begin{matrix}\tilde{A} = ( \begin{matrix}I & I & 0 \\ I & - I & λ I\end{matrix} ) & \tilde{x} = ( \begin{matrix}d \\ u \\ n\end{matrix} ) & \tilde{b} = ( \begin{matrix}{A}^{- 1} p \\ {A}^{- 1} z\end{matrix} )\end{matrix} ,$$

wherein d represents a down-going seismic wavefield, u represents an up-going seismic wavefield, n represents the noise and λ represents a user-chosen scalar to adjust emphasis of the noise. A constrained minimization is solved in the computer according to the expression

$$\tilde{x} = arg min μ {‖ \tilde{x} ‖}_{1} + \frac{1}{2} {‖ \tilde{x} ‖}_{2}^{2} \qquad s . t . \qquad \tilde{A} \tilde{x} = \tilde{b}$$

for \tilde{x}; wherein μ represents a user-chosen scalar to adjust relative importance of minimization norms. The solved constrained minimization is inverse transformed in the computer and reordered back into a domain of the input seismic signals. An output is generated by the computer comprising one or more of an estimate of the noise in the particle motion wavefield, an estimate of the down-going pressure wavefield and an estimate of the upgoing (deghosted) pressure wavefield.

An another aspect of the present disclosure, a computer program is stored in a non-transitory computer readable medium. The program comprises logic operable to cause a programmable computer or computer system to perform action according to either of the above-described aspects of this disclosure.

In some embodiments, the sparsity promoting transformation comprises at least one of, a Fourier transform, a Radon transform, Wavefield extrapolation, Normal moveout correction, 1 dimensional filtering, 2 dimensional filtering, 3 dimensional filtering and wavelet transforming.

Some embodiments further comprise repeating the applying, constructing, solving inverse transforming and generating an output in overlapping 1 dimensional, 2 dimensional or 3 dimensional windows.

In some embodiments, the sparsity promoting transform is based on one or more of the following functions: Activelet, AMlet, Armlet, Bandlet, Barlet, Bathlet, Beamlet, Binlet, Bumplet, Brushlet, Caplet, Camplet, Chirplet, Chordlet, Circlet, Coiflet, Contourlet, Cooklet, Craplet, Cubelet, CURElet, Curvelet, Daublet, Directionlet, Dreamlet, Edgelet, FAMlet, FLaglet, Flatlet, Fourierlet, Framelet, Fresnelet, Gaborlet, GAMlet, Gausslet, Graphlet, Grouplet, Haarlet, Haardlet, Heatlet, Hutlet, Hyperbolet, Icalet (Icalette), Interpolet, Loglet, Marrlet, MIMOlet, Monowavelet, Morelet, Morphlet, Multiselectivelet, Multiwavelet, Needlet, Noiselet, Ondelette, Ondulette, Prewavelet, Phaselet, Planelet, Platelet, Purelet, QVlet, Radonlet, RAMlet, Randlet, Ranklet, Ridgelet, Riezlet, Ripplet (original, type-I and II), Scalet, S2let, Seamlet, Seislet, Shadelet, Shapelet, Shearlet, Sinclet, Singlet, Slantlet, Smoothlet, Snakelet, SOHOlet, Sparselet, Spikelet, Splinelet, Starlet, Steerlet, Stockeslet, SURE-let (SURElet), Surfacelet, Surflet, Symmlet, S2let, Tetrolet, Treelet, Vaguelette, Wavelet-Vaguelette, Wavelet, Warblet, Warplet, Wedgelet, Xlet.

In some embodiments, matrix Ã and column vectors \tilde{b} and \tilde{x} are populated according to definitions comprising

$$\tilde{A} = ( \begin{matrix}{A}_{0} & {A}_{1} & 0 \\ {A}_{2} & - {A}_{3} & λ {A}_{4}\end{matrix} ) \qquad \tilde{x} = ( \begin{matrix}d \\ u \\ n\end{matrix} ) \qquad \tilde{b} = ( \begin{matrix}p \\ z\end{matrix} ) ,$$

wherein A₁, A₂, A₃ and A₄ comprise inverse sparsity promoting transforms.

In some embodiments, the detected particle motion signals are detected along a direction other than vertical and the estimated noise is along a direction co-linear with the detected direction.

In some embodiments, the co-linear direction comprises at least one forward-going (F), backward-going (B), right-going (R) and left-going (L) with reference to a direction of the spaced apart locations with reference to the seismic energy source.

In some embodiments, seismic signals are detected on the bottom of a body of water.

Another aspect of the present disclosure relates to method for estimating noise in particle motion seismic sensor recordings resulting from interface waves back-scattered from shallow heterogeneities. A method according to this aspect includes sending as input to a computer seismic signals comprising pressure related signals and particle motion related signals detected on a bottom of a body of water in response to actuation of a seismic energy source. In the computer, a sparsity promoting transformation is applied to the input seismic signals. In the computer, constructing a matrix Ã and column vector \tilde{b} are constructed according to the expression:

$$\begin{matrix}\tilde{A} = ( \begin{matrix}I & I & 0 \\ I & - I & λ I\end{matrix} ) & \tilde{x} = ( \begin{matrix}d \\ u \\ n\end{matrix} ) & \tilde{b} = ( \begin{matrix}{A}^{- 1} p \\ {A}^{- 1} z\end{matrix} )\end{matrix} ,$$

wherein d represents a down-going seismic wavefield, u represents an up-going seismic wavefield, n represents the noise and λ represents a user-chosen scalar to adjust emphasis of the noise. In the computer, solving A constrained minimization is solved according to the expression

$$\tilde{x} = arg min μ {‖ \tilde{x} ‖}_{1} + \frac{1}{2} {‖ \tilde{x} ‖}_{2}^{2} \qquad s . t . \qquad \tilde{A} \tilde{x} = \tilde{b} \qquad for \tilde{x} ;$$

wherein μ represents a user-chosen scalar to adjust relative importance of minimization norms. In the computer, the solved constrained minimization is inverse transformed and reordered back into a domain of the input seismic signals; and in the computer, an output is generated comprising an estimate of the noise in the particle motion related signals resulting from the interface waves.

Some embodiments further comprise, in the computer, generating an output comprising up-going and down-going total wavefields.

In some embodiments, the sparsity promoting transformation comprises at least one of, a Fourier transform, a Radon transform, Wavefield extrapolation, Normal moveout correction, 1 dimensional filtering, 2 dimensional filtering, 3 dimensional filtering and wavelet transforming.

Some embodiments further comprise repeating the applying, constructing, solving inverse transforming and generating an output in overlapping 1 dimensional, 2 dimensional or 3 dimensional windows.

In some embodiments, the sparsity promoting transform is based on one or more of the following functions: Activelet, AMlet, Armlet, Bandlet, Barlet, Bathlet, Beamlet, Binlet, Bumplet, Brushlet, Caplet, Camplet, Chirplet, Chordlet, Circlet, Coiflet, Contourlet, Cooklet, Craplet, Cubelet, CURElet, Curvelet, Daublet, Directionlet, Dreamlet, Edgelet, FAMlet, FLaglet, Flatlet, Fourierlet, Framelet, Fresnelet, Gaborlet, GAMlet, Gausslet, Graphlet, Grouplet, Haarlet, Haardlet, Heatlet, Hutlet, Hyperbolet, Icalet (Icalette), Interpolet, Loglet, Marrlet, MIMOlet, Monowavelet, Morelet, Morphlet, Multiselectivelet, Multiwavelet, Needlet, Noiselet, Ondelette, Ondulette, Prewavelet, Phaselet, Planelet, Platelet, Purelet, QVlet, Radonlet, RAMlet, Randlet, Ranklet, Ridgelet, Riezlet, Ripplet (original, type-I and II), Scalet, S2let, Seamlet, Seislet, Shadelet, Shapelet, Shearlet, Sinclet, Singlet, Slantlet, Smoothlet, Snakelet, SOHOlet, Sparselet, Spikelet, Splinelet, Starlet, Steerlet, Stockeslet, SURE-let (SURElet), Surfacelet, Surflet, Symmlet, S2let, Tetrolet, Treelet, Vaguelette, Wavelet-Vaguelette, Wavelet, Warblet, Warplet, Wedgelet, Xlet.

In some embodiments, matrix Ã and column vectors \tilde{b} and \tilde{x} are populated according to definitions comprising

$$\tilde{A} = ( \begin{matrix}{A}_{0} & {A}_{1} & 0 \\ {A}_{2} & - {A}_{3} & λ {A}_{4}\end{matrix} ) \qquad \tilde{x} = ( \begin{matrix}d \\ u \\ n\end{matrix} ) \qquad \tilde{b} = ( \begin{matrix}p \\ z\end{matrix} ) ,$$

wherein A₁, A₂, A₃ and A₄ comprise sparsity promoting transforms.

Some embodiments further comprise generating an output comprising up-going and down-going total wavefields.

In some embodiments, the sparsity promoting transformation comprises at least one of, a Fourier transform, a Radon transform, Wavefield extrapolation, Normal moveout correction, 1 dimensional filtering, 2 dimensional filtering, 3 dimensional filtering and wavelet transforming.

In some embodiments, comprising repeating the applying, constructing, solving inverse transforming and generating an output in overlapping 1 dimensional, 2 dimensional or 3 dimensional windows.

Other aspects and possible advantages will be apparent from the description and claims that follow.

### BRIEF DESCRIPTION OF THE DRAWINGS

FIGS. 1A through 1D show an example of what is known in the art as a shot record that has been recorded using pressure (FIG. 1A) and particle velocity detectors (FIG. 1B). The noise estimated by a method according to the present disclosure is shown in FIG. 1C and the upgoing (deghosted) wavefield is shown in FIG. 1D.

FIG. 2 shows an example embodiment of an Earth model used to generate synthetic seismic data.

FIGS. 3A through 3D show, respectively, synthetic pressure or pressure time derivative data and synthetic vertical particle motion data in a common receiver gather, and in a common shot gather. These synthetic seismic data were generated using an Earth model as explained with reference to FIG. 2.

FIGS. 4A through 4D show what is known in the art as a common offset section. This is a collection of recordings from one detector for many shots. FIG. 4A shows the pressure recordings and FIG. 4B shows the particle velocity detector recordings. The noise estimated by methods according to the current disclosure is shown in FIG. 4C and the upgoing (deghosted) wavefield is shown in FIG. 4D.

FIGS. 5A through 5D show, respectively, the results of applying a method according to the present disclosure to the synthetic data shown in FIG. 3.

FIGS. 6A through 6C show the results of applying a method according to the present disclosure to real ocean-bottom motion sensor data. FIG. 6A shows the unprocessed motion sensor data, FIG. 6B shows the motion sensor data after the Vz-noise has been removed using the present method. FIG. 6C shows the estimated Vz-noise that has been removed.

FIG. 7 shows an example computer system that may be used in some embodiments.

FIG. 8 show an example embodiment of a seismic acquisition system that may be used in accordance with the present disclosure.

### DETAILED DESCRIPTION

Seismic data that may be used in accordance with methods of the present disclosure may be acquired using apparatus and methods disclosed, for example; in U.S. Pat. No. 5,774,417 issued to Corrigan et al. The system disclosed in the '417 patent is only provided as an example of apparatus that may be used in connection with the present disclosure and is in no way intended to limit the scope of the present disclosure. Such systems may include a cable having spaced apart particle motion sensors and pressure or pressure time gradient sensors, wherein the cable is deployed on the water bottom. However, providing example data acquisition according to the '417 patent does not preclude such methods as towing or suspending the cable of detectors at specified depths in the water column. Towed cables are also known in the art as streamers. The sensors, e.g., individually or in streamers may also be disposed in or towed by individual autonomous underwater vehicles. Signals detected by the sensors or receivers in the disclosed apparatus may be recorded. See, for example, U.S. Pat. No. 7,239,577 issued to Tenghamn et al. for an example embodiment of a streamer that comprises both pressure responsive sensors and particle motion responsive sensors. As that term is used in this disclosure, “pressure related” signals means signals generated in response to absolute pressure or changes in pressure, e.g., time derivative of pressure where the detectors are disposed. “Motion related” signals means signals produced as a result of motion imparted to the sensors as a result of, e.g., velocity or acceleration of the medium in which the detectors are disposed.

For each actuation of a seismic energy source, the detected signals may comprise both upwardly propagating seismic energy and downwardly propagating seismic energy. The respective upward and downward propagating seismic energy may be referred to as a respective “wavefield.”

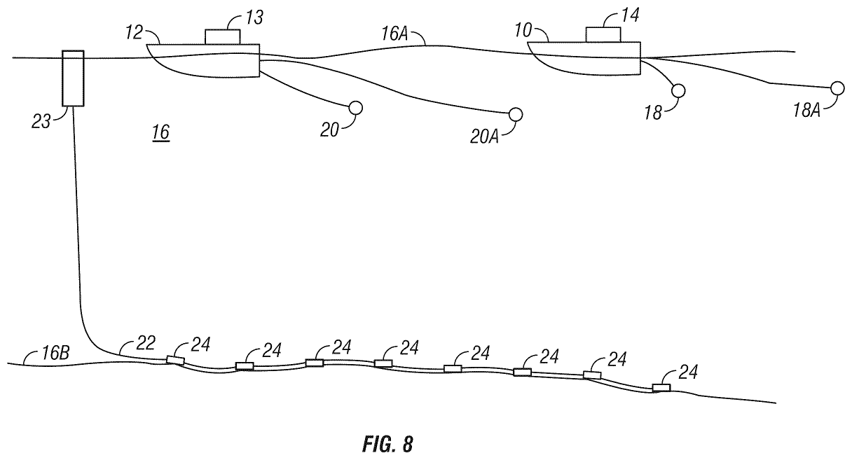

FIG. 8 shows a vertical section view of an ocean bottom cable (OBC) seismic survey being conducted using, for example, two different “source” vessels for towing seismic energy sources. In some embodiments, only one source vessel may be used. According to the present disclosure, any number of source vessels may be used and the following description is not intended to limit the scope of the present disclosure. The source vessels move along the surface 16A of a body of water 16 such as a lake or the ocean. In the present example, a vessel referred to as a “primary source vessel” 10 may include equipment, shown generally at 14, that comprises components or subsystems (none of which is shown separately) for navigation of the primary source vessel 10, for actuation of seismic energy sources and for retrieving and processing seismic signal recordings. The primary source vessel 10 is shown towing two, spaced apart seismic energy sources 18, 18A.

The equipment 14 on the primary source vessel 10 may be in signal communication with corresponding equipment 13 (including similar components to the equipment on the primary source vessel 10) disposed on a vessel referred to as a “secondary source vessel” 12. The secondary source vessel 12 in the present example also tows spaced apart seismic energy sources 20, 20A near the water surface 16A. In the present example, the equipment 14 on the primary source vessel 10 may, for example, send a control signal to the corresponding equipment 13 on the secondary source vessel 12, such as by radio telemetry, to indicate the time of actuation (firing) of each of the sources 18, 18A towed by the primary source vessel 10. The corresponding equipment 13 may, in response to such signal, actuate the seismic energy sources 20, 20A towed by the secondary source vessel 12.

The seismic energy sources 18, 18A, 20, 20A may be air guns, water guns, marine vibrators, or arrays of such devices. The seismic energy sources are shown as discrete devices in FIG. 8 to illustrate the general principle of seismic signal acquisition. The type of and number of seismic energy sources that can be used in any embodiment is not intended to limit the scope of the disclosure.

In FIG. 8, an OBC 22 is deployed on the bottom 16B of the water 16 such that spaced apart seismic receiver modules 24 are disposed on the water bottom 16B in a preselected pattern. The receiver modules 24 may include a pressure or pressure time gradient responsive seismic sensor, and one or more seismic particle motion sensors, for example, one-component or three-component geophones, or one- or three-component accelerometers (none of the sensors are shown separately). The type of and the number of seismic sensors in each module 24 is not intended to limit the scope of the disclosure. The seismic sensors in each module 24 generate electrical and/or optical signals (depending on the sensor type) in response to, in particular, detected seismic energy resulting from actuations of the seismic energy sources 18, 18A, 20, 20A. In some embodiments, the sensors may comprise pressure or pressure time derivative sensors such as hydrophones, and one or more particle motion responsive sensors such as geophones or accelerometers. In some embodiments, such particle motion responsive sensors may be oriented so as to be sensitive principally (ignoring any cross-component coupling for purposes of explanation) to vertical particle motion. The signals generated by the various sensors may be conducted to a device near the water surface 16A such as a recording buoy 23, which may include a data recorder (not shown separately) for storing the signals for later retrieval and processing by the equipment 14 on the primary source vessel 10, or other processing equipment to be described further below. The data storage functions performed by the recording buoy 23 may be performed by different types of equipment, such as a data storage unit on a recording vessel (not shown) or a recording module (not shown) deployed on the water bottom 16B, e.g., proximate each sensor module 24, or even on the primary or secondary source vessels. Accordingly, the disclosure is not limited in scope to use with a recording buoy or any other specific recording device(s).

Although the description of acquiring signals explained with reference to FIG. 8 is for sensors deployed on the water bottom, it will be appreciated that it is possible to obtain corresponding measurements at any selected depth in the water, using, for example, seismic sensors disposed in a towed cable such as described in the above referenced U.S. Pat. No. 7,239,577 issued to Tenghamn, et al.

Having acquired seismic data as explained above, methods for processing such data according to the present disclosure will now be explained. The total recorded pressure wavefield, P, and the total vertical particle motion, e.g., velocity, wavefield, V, can be represented as the superposition of the up-going and down-going wavefields, such as by the expressions:

$$\begin{matrix}P = D + U \\ V = \frac{cos ( θ )}{ρ α} ( D - U )\end{matrix} . \qquad ( 1 )$$

The seismic propagation velocity and bulk density are represented by α and ρ respectively, while θ is the propagation direction with reference to vertical (measured from a downward pointing depth axis). Eq. (1) may be solved for the up-going (U) and the down-going (D) pressure wavefields as:

$$\begin{matrix}U = \frac{1}{2} ( P - \frac{ρ α}{cos θ} V ) \\ D = \frac{1}{2} ( P + \frac{ρα}{cos θ} V )\end{matrix} \qquad ( 2 )$$

Eq. (2) shows how to derive U and D from the recorded pressure (P) and particle velocity (V) data. Eq. (2) assumes that the recorded data is uncontaminated by noise, that the respective wavefields are compatibly scaled and that any wavelet differences have been removed.

For simplicity of exposition, the pressure-normalized particle velocity Z may be defined as:

$$Z = \frac{ρ α}{cos θ} V \qquad ( 3 )$$

Substitution of Eq. (3) into Eq. (1) and then adding a term to represent the noise (λN) contained in the particle motion component provides the expression:

P=D+U

Z=D−U+λN^{⋅} (4)

The parameter λ in Eq. (4) is a user-chosen scalar that allows the user to adjust the emphasis of the noise term in Eq. 4, N, which represents the noise component of the particle motion (e.g., velocity) sensor wavefield. An initial choice of λ=1 is reasonable, potentially followed by varying that value and assessing the quality of the results.

The system of equations in Eq. (4) is underdetermined. In order to determine the components U, D and N from the two recorded wavefields, P and Z, it is necessary to provide some form of additional assistance in order to solve the underdetermined system. Underdetermined systems of equations are satisfied by an infinite number of solutions. In order to choose one of those solutions, some kind of constraint(s) is (are) required. One widely used constraint requires that the L₁ norm of the solution (the sum of the absolute values of the solution column-vector) be minimized. This is a measure of simplicity and it is known in the art as “sparsity”, meaning that only a small number of elements in the solution vector are non-zero. In the context of methods according to the present disclosure, an approach known as “joint sparsity recovery” (Baron et al., 2009) may be used. Joint sparsity assumes that there is a common component in two or more objects (here, wavefields) and that because they are common components they only need to be described once, rather than twice. Since such common components will be derived as part of the solution, the solution can reasonably be argued to be sparse. It will be noted that in Eq. (4), the down-going (D) and up-going (U) wavefields are common components. As may be suggested by the joint sparsity recovery approach (Baron et al., 2009), Eq. (4) may be rewritten in matrix-vector form with the unknowns (D, U, and N) and measured wavefields (P and Z) reordered so that they form column vectors:

$$( \begin{matrix}A & A & 0 \\ A & - A & λ A\end{matrix} ) \cdot ( \begin{matrix}d \\ u \\ n\end{matrix} ) = ( \begin{matrix}p \\ z\end{matrix} ) . \qquad ( 5 )$$

Eq. (5) expresses the pressure-normalized sensor data (p, z) as transformed linear combinations of the up-going (u) and down-going (d) wavefields along with additive noise (n) assumed to be present in the vertical component. In methods that exploit sparsity, it is common to enhance the sparsity by applying certain transformations. These are known in the art as “sparsity promoting transforms.” A common transformation in image processing, for example, might be a wavelet transform, which is widely used because it has the capability substantially to represent an image with relatively few coefficients in the transformed domain. The wavelet transform therefore forms the basis of many image compression techniques. In seismic data processing, one widely used transformation is the complex curvelet transform, because similarly, it is capable of representing seismic wavefields with relatively few curvelet coefficients. Consequently, in the joint sparsity recovery approach, the sub-matrix A is typically the inverse of a sparsity promoting transform. In some embodiments A can additionally contain other operators such as 1D, 2D or 3D band limiting filters and/or dip-filters. The other operators may also contain such transformations as Fourier transforms and normal moveout corrections. In the special case that A=I, where I is the identity matrix, the system of Eq. (5) reduces exactly to Eq. (4).

Since the system of Eq. (5) is under-determined it cannot be solved uniquely without some form of constraint. As described above, the joint sparsity recovery approach as disclosed in Baron et al. (2009) describes a forward model in which all measurements share one or more common sparse components while each individual measurement may contain a unique (sometimes “innovation”) component in a sparsity promoting transform domain. Oghenekohwo et al. (2017) discloses using the foregoing approach to decompose several vintages of seismic data to determine so-called 4D (time lapse) changes. The method disclosed in Oghenekohwo et al. uses the following system of equations:

$$( \begin{matrix}{A}_{1} & {A}_{1} & 0 \\ {A}_{2} & 0 & {A}_{2}\end{matrix} ) \cdot ( \begin{matrix}{z}_{0} \\ {z}_{1} \\ {z}_{2}\end{matrix} ) = ( \begin{matrix}{y}_{1} \\ {y}_{2}\end{matrix} ) . \qquad ( 6 )$$

in which z₀ is a shared common component, z₁ contains features unique to data y₁ and similarly for z₂ and y₂. The solutions, zⱼ are in a sparsity promoting domain and the sub-matrices Aᵢ are inverse sparsity-promoting transforms that transform back to the input domain of yᵢ. The system of equations in Eq. (6) may be solved using “basis pursuit”:

\tilde{z}=argmin∥z∥\tilde{z}μ₁ subject to \tilde{A}\tilde{z}=\tilde{y}, (7)

that is, what is sought is the simplest solution (in the L₁ norm sense) that fits the data. Importantly, the foregoing does not consider noise. In related work, Tian et al. (2018) examined the same problem except that they assumed that the data were on coincident, regular computational grids and additionally contained additive incoherent noise (n),

$$( \begin{matrix}{A}_{0} & {A}_{1} & 0 \\ {A}_{0} & 0 & {A}_{2}\end{matrix} ) \cdot ( \begin{matrix}{z}_{0} \\ {z}_{1} \\ {z}_{2}\end{matrix} ) + ( \begin{matrix}{n}_{1} \\ {n}_{2}\end{matrix} ) = ( \begin{matrix}{y}_{1} \\ {y}_{2}\end{matrix} ) . \qquad ( 8 )$$

Tian et al. solved the foregoing system of equations by using “basis pursuit denoise” according to the expression:

\tilde{z}=argmin∥\tilde{z}μ₁ subject to ∥Ã\tilde{z}=\tilde{y}∥₂≤σ. (9)

The above expression finds the simplest solution (in the L₁ norm sense) that fits the data to within a specified tolerance (σ). The tolerance is a user specified parameter chosen so that the residual energy (as a desired result) contains only the noise. It is assumed in such a solution that the noise is unpredictable and therefore cannot easily be represented in a sparsity promoting transform domain, and so it remains uncategorized in the residual.

Oghenekohwo et al. (2017) and Tian et al. (2018) embed the inverse sparsity-promoting transforms as the sub-matrices A,. This has the advantage that the inverse sparsity-promoting transforms A may be tailored to suit the particular problem. This choice is also available in a method according to the present disclosure by allowing the sub-matrices to vary in the system of equations (5),

$$( \begin{matrix}{A}_{0} & {A}_{1} & 0 \\ {A}_{2} & - {A}_{3} & λ {A}_{4}\end{matrix} ) \cdot ( \begin{matrix}d \\ u \\ n\end{matrix} ) = ( \begin{matrix}p \\ z\end{matrix} ) . \qquad ( 10 )$$

In order to solve Eq. (10) it is known to make the following definitions,

$$\begin{matrix}\tilde{A} = ( \begin{matrix}{A}_{0} & {A}_{1} & 0 \\ {A}_{2} & - {A}_{3} & λ {A}_{4}\end{matrix} ) & \tilde{x} = ( \begin{matrix}d \\ u \\ n\end{matrix} ) & \tilde{b} = ( \begin{matrix}p \\ z\end{matrix} )\end{matrix} , \qquad ( 11 )$$

Then, one may write the solution of the above system of equations in the form of a basis pursuit problem that contains an extra L₂ regularization term:

$$\begin{matrix}\tilde{x} = arg min μ {‖ \tilde{x} ‖}_{1} + \frac{1}{2} {‖ \tilde{x} ‖}_{2}^{2} & s . t . & \tilde{A} \tilde{x} = \tilde{b} ,\end{matrix} \qquad ( 12 )$$

in which μ is a user specifiable scalar parameter that can be adjusted to control the importance of the L₁ versus L₂ norms of the solution vector, \tilde{x}. A reasonable initial value for μ=Ã^{H}\tilde{b}, potentially followed by varying that value and assessing the quality of the results. The form of Eq. (12) is sometimes referred to as “regularized basis pursuit”. Since the solutions are in the (sparsity promoting) transform domain, inverse transformation is required to complete the procedure. It may be demonstrated that the linearized split Bregman (LSB) algorithm (Goldstein & Osher, 2008) for solving the basis pursuit problem converges in the limit to the constrained minimization of Eq. (12).

However, because such systems of equations are solved iteratively, the computational cost of an iteration becomes an important consideration. At each iteration it is necessary to evaluate expressions of the form Ãs and Ã^{H}t in which s and t are column vectors conformable for matrix multiplication, Ã is defined in Eq. (11) and H denotes Hermitian matrix transpose. This iteration has complexity O(n³). However, if Aᵢ=Aⱼ for all i≠j, there is no need to place the transforms inside the iteration. Pre-multiplication of the system of Eq. (5) as follows:

$$\begin{matrix}( \begin{matrix}{A}^{- 1} & 0 \\ 0 & {A}^{- 1}\end{matrix} ) ( \begin{matrix}A & A & 0 \\ A & - A & λ A\end{matrix} ) \cdot ( \begin{matrix}d \\ u \\ n\end{matrix} ) = ( \begin{matrix}{A}^{- 1} & 0 \\ 0 & {A}^{- 1}\end{matrix} ) ( \begin{matrix}p \\ z\end{matrix} ) \\ ( \begin{matrix}I & I & 0 \\ I & - I & λ I\end{matrix} ) \cdot ( \begin{matrix}d \\ u \\ n\end{matrix} ) = ( \begin{matrix}{A}^{- 1} p \\ {A}^{- 1} z\end{matrix} )\end{matrix} , \qquad ( 13 )$$

shows that the reverse inverse sparsity promoting operator (=the forward sparsity promoting operator) can be applied to the input data rendering the partitioned matrix on the left-hand side very fast and simple to apply with complexity O(n). In simple terms, one may transform the input data into the sparsity promoting domain, solve the simple system of equations more efficiently and inverse transform the solution into to original input domain.

Assuming, as discussed above, the form of Eq. (13) and let,

$$\begin{matrix}\tilde{A} = ( \begin{matrix}I & I & 0 \\ I & - I & λ I\end{matrix} ) & \tilde{x} = ( \begin{matrix}d \\ u \\ n\end{matrix} ) & \tilde{b} = ( \begin{matrix}{A}^{- 1} p \\ {A}^{- 1} z\end{matrix} ) .\end{matrix} \qquad ( 14 )$$

In the same way that Eq. (10) was solved using the definitions of Eq. (11) and the minimization of Eq. (12), Eq. (13) may be solved using the definitions of Eq. (14) and the minimization of Eq. (12).

The choice of sparsity promoting transform is an important consideration. In one possible embodiment the curvelet transform is used, in other embodiments NMO (normal moveout correction) may be included. Other embodiments may include, 1D-, 2D- or 3D-band-pass or dip filters and/or Fourier transformation. However, these embodiments are not intended to limit the scope of this disclosure.

In some embodiments, the sparsity promoting transform may be based on one or more of the following functions: Activelet, AMlet, Armlet, Bandlet, Barlet, Bathlet, Beamlet, Binlet, Bumplet, Brushlet, Caplet, Camplet, Chirplet, Chordlet, Circlet, Coiflet, Contourlet, Cooklet, Craplet, Cubelet, CURElet, Curvelet, Daublet, Fresnelet, Gaborlet, GAMlet, Gausslet, Graphlet, Grouplet, Haarlet, Haardlet, Heatlet, Hutlet, Hyperbolet, Icalet (Icalette), Interpolet, Loglet, Marrlet, MIMOlet, Monowavelet, Morelet, Morphlet, Multiselectivelet, Multiwavelet, Needlet, Noiselet, Ondelette, Ondulette, Prewavelet, Phaselet, Planelet, Platelet, Purelet, QVlet, Radonlet, RAMlet, Randlet, Ranklet, Ridgelet, Riezlet, Ripplet (original, type-I and II), Scalet, S2let, Seamlet, Seislet, Shadelet, Shapelet, Shearlet, Sinclet, Singlet, Slantlet, Smoothlet, Snakelet, SOHOlet, Sparselet, Spikelet, Splinelet, Starlet, Steerlet, Stockeslet, SURE-let (SURElet), Surfacelet, Surflet, Symmlet, S2let, Tetrolet, Treelet, Vaguelette, Wavelet-Vaguelette, Wavelet, Warblet, Warplet, Wedgelet, Xlet.

To summarize the actions required in one embodiment to estimate the noise on the vertical particle motion sensor recording and to separate the wavefield into upgoing (deghosted) and downgoing components:
1. Input pressure or pressure time derivative P and pressure-normalised particle motion Z signals obtained by actuation of a seismic energy source.
2. Apply column vector ordering and a sparsity-promoting transform, A⁻¹ to the input pressure or pressure time derivative and normalized particle motion P→A⁻¹p, Z→A⁻¹z.
3. Specify a scalar user parameter, λ, to control the importance of the noise component.
4. Construct matrix Ã and column vector \tilde{b} according to Eq. (14).
5. Specify the user scalar parameter, μ, to control the relative importance of the L₁ versus L₂ norms and solve constrained minimization of Eq. (12) for \tilde{x}.
6. Inverse transform and reorder \tilde{x}: Ad→D, Au→U and An→N.
7. Output D, U and N .

Although the description has set forth one possible embodiment in which the noise contained in the vertical component of particle motion (e.g., velocity) has been estimated and the wavefield has been separated into up-going (deghosted) and downgoing components, the present methods of noise estimation and wavefield separation may be similarly applied to other particle motion components. For example three mutually perpendicular particle motion sensors, x, y and z, may be recorded along with the pressure or pressure time derivative. If a right-handed co-ordinate system is adopted that is rotated so that the z-axis points down (consistent with the detailed disclosure so far) and the x-axis is oriented to point along the length of the sensor streamer, then the following definitions can be made,

$$\begin{matrix}X = \frac{ρα}{sin θ cos ϕ} {V}_{x} \\ Y = \frac{ρα}{sin θ sin ϕ} {V}_{y} \\ Z = \frac{ρα}{cos θ} {V}_{z}\end{matrix} , \qquad ( 15 )$$

the third of which is identically equation (3). The azimuthal angle, measured clockwise from the y-axis in the x-y plane, is denoted ϕ, the subscripts indicate the axis over which the component of the particle velocity, V_{x,y,z,} is measured and the left-hand sides represent the pressure normalised versions of each particle velocity component. As might be expected, since, Z and P allow the wavefield to be separated into down-going and up-going pressure wavefields, so does X and P allow the wavefield to be separated into forward-going (F) and backward-going (B) pressure wavefields, as does Y and P allow the wavefield to be separated into right-going (R) and /eft-going (L) pressure wavefields. It therefore follows that equation (4) may be more generally written to apply to each of the mutually orthogonal components,

P=F+B

X=F−B+λₓNₓ^{⋅} (16)

P=R+L

Y=R−L+λ_{y}N_{y}^{⋅} (17)

P=D+U

Z=D−U+λ_{z}N_{z}^{⋅} (18)

and that each particle motion component may have its noise component (Nₓ, N_{y}, N_{z}, respectively) estimated using the same procedure described above as those familiar with the art will now recognise. It will be recognised that equation (18) is the same as equation (3) as should be the case.

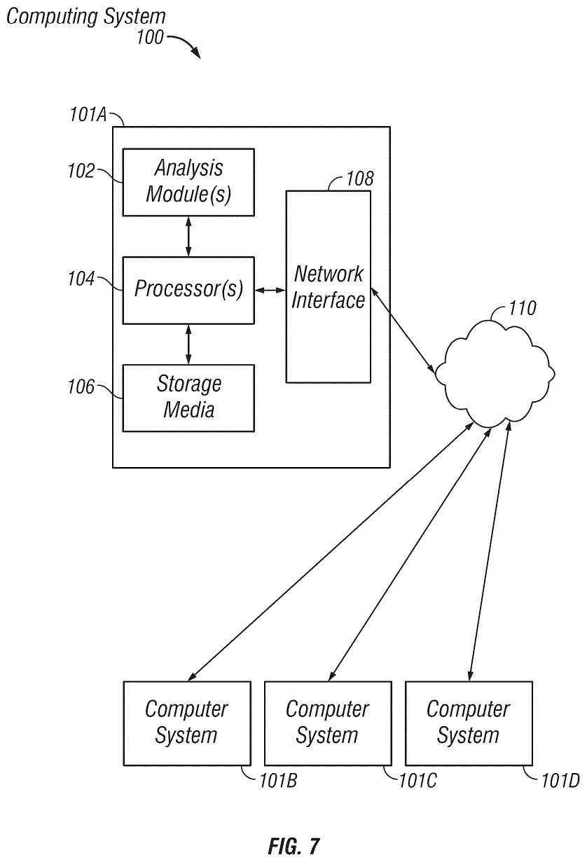

FIG. 7 shows an example computing system 100 in accordance with some embodiments that can perform the actions of a method according to this disclosure. The computing system 100 may be an individual computer system 101A or an arrangement of distributed computer systems. The individual computer system 101A may include one or more analysis modules 102 that may be configured to perform various tasks according to some embodiments, such as the tasks explained with reference to FIG. 7. To perform these various tasks, the analysis module 102 may operate independently or in coordination with one or more processors 104, which may be connected to one or more storage media 106. A display device such as a graphic user interface of any known type may be in signal communication with the processor 104 to enable user entry of commands and/or data and to display results of execution of a set of instructions according to the present disclosure.

The processor(s) 104 may also be connected to a network interface 108 to allow the individual computer system 101A to communicate over a data network 110 with one or more additional individual computer systems and/or computing systems, such as 101B, 101C, and/or 101D (note that computer systems 101B, 101C and/or 101D may or may not share the same architecture as computer system 101A, and may be located in different physical locations, for example, computer systems 101A and 101B may be at a well drilling location, while in communication with one or more computer systems such as 101C and/or 101D that may be located in one or more data centers on shore, aboard ships, and/or located in varying countries on different continents).

A processor may include, without limitation, a microprocessor, microcontroller, processor module or subsystem, programmable integrated circuit, programmable gate array, or another control or computing device.

The storage media 106 may be implemented as one or more computer-readable or machine-readable storage media. Note that while in the example embodiment of FIG. 7 the storage media 106 are shown as being disposed within the individual computer system 101A, in some embodiments, the storage media 106 may be distributed within and/or across multiple internal and/or external enclosures of the individual computing system 101A and/or additional computing systems, e.g., 101B, 101C, 101D. Storage media 106 may include, without limitation, one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that computer instructions to cause any individual computer system or a computing system to perform the tasks described above may be provided on one computer-readable or machine-readable storage medium, or may be provided on multiple computer-readable or machine-readable storage media distributed in a multiple component computing system having one or more nodes. Such computer-readable or machine-readable storage medium or media may be considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

It should be appreciated that computing system 100 is only one example of a computing system, and that any other embodiment of a computing system may have more or fewer components than shown, may combine additional components not shown in the example embodiment of FIG. 7, and/or the computing system 100 may have a different configuration or arrangement of the components shown in FIG. 7. The various components shown in FIG. 7 may be implemented in hardware, software, or a combination of both hardware and software, including one or more signal processing and/or application specific integrated circuits.

Further, the acts of the processing methods described above may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of the present disclosure.

### EXAMPLES

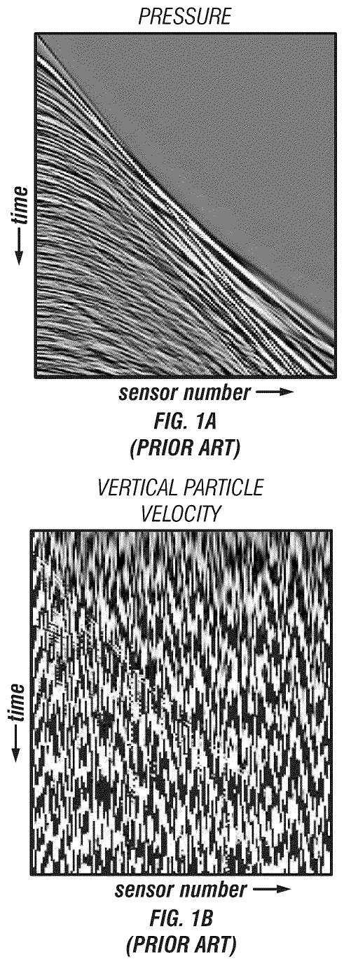

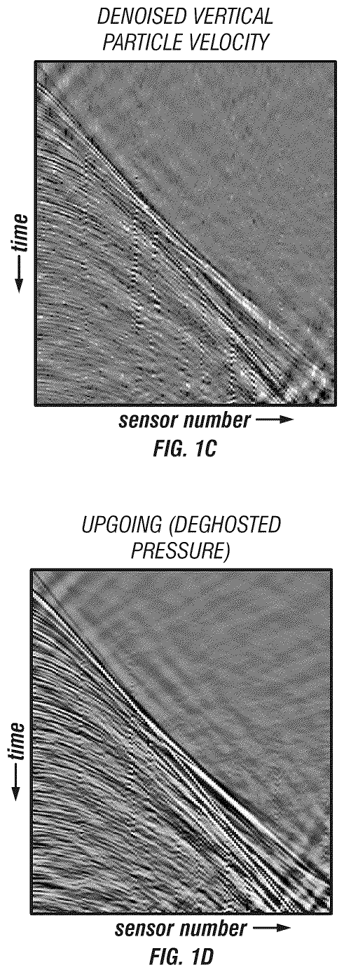

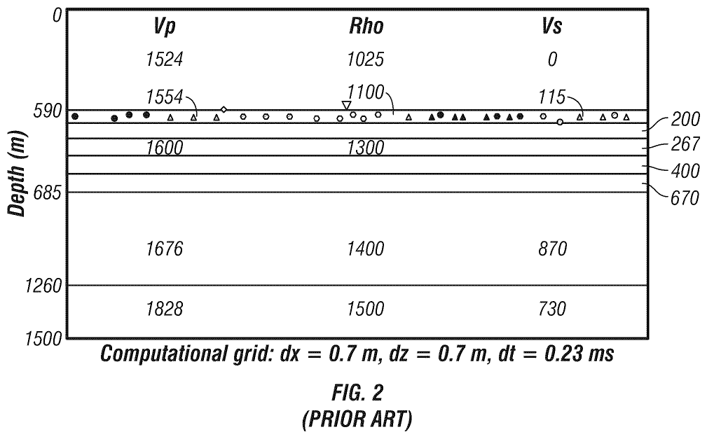

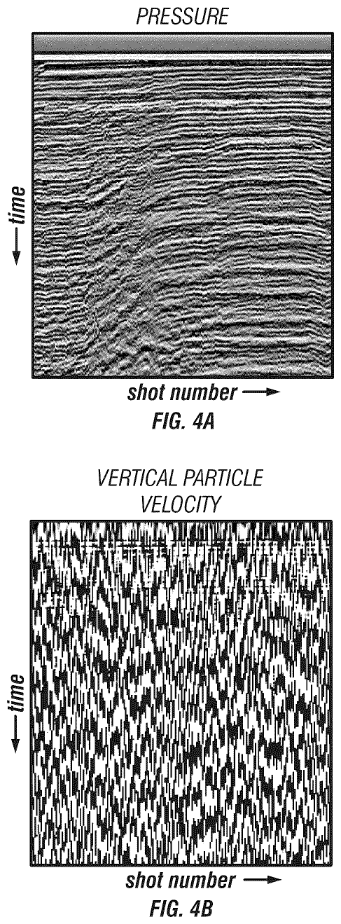

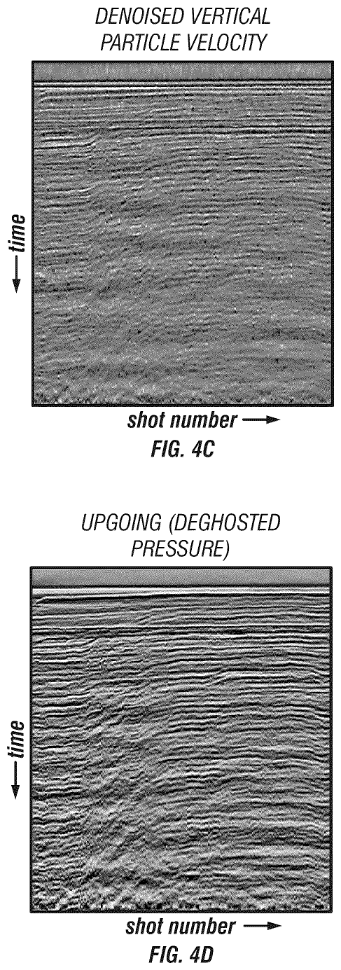

To demonstrate the performance of a method according to the present disclosure, one embodiment of such method has been applied to real seismic data shown in FIGS. 1A through 1D. FIGS. 1A and 1B show the recordings from a plurality of detectors contained at spaced apart locations in a towed streamer. A seismic energy source has been actuated to induce seismic waves in the water, and detected signals are displayed in a 2D display with reference to time and detector. Such records are known in the art as shot records. FIG. 1A shows hydrophone (pressure time derivative) sensor recordings at increasing distances from the source. FIG. 1B shows the recording of particle velocity sensors at the same locations with reference to the source as in FIG. 1A. It is apparent that the particle motion recordings contain considerable noise that obscures the events of interest. FIG. 1C shows the particle motion sensor signals with the noise as estimated by a method according to this current disclosure having been removed. FIG. 1D shows the upgoing (deghosted) wavefield estimated by a method according to the present disclosure. This dataset also contained many hundreds of such shot records that were recorded along a line of traverse. The disclosed method was applied to all of those shot records and a single sensor was selected from each shot for display. This is known in the art as a common channel or common offset section. FIGS. 4A through 4D display the common channel sections at each of the equivalent processing stages as depicted in FIGS. 1A through 1D: FIG. 4A shows the hydrophone sensor recordings at a constant distance from the source for every shot fired (all source actuations). FIG. 4B shows the recording of particle velocity sensors at the same locations with reference to the source. It is apparent that the particle motion recording contains considerable noise that obscures the events of interest. FIG. 4C shows the particle motion sensor recordings with the noise estimated by a method according to this current disclosure removed. FIG. 4D shows the upgoing (deghosted) wavefield estimated by a method according to the present disclosure. It is apparent that the noise has been effectively removed and that the upgoing (deghosted) wavefield has been successfully estimated.

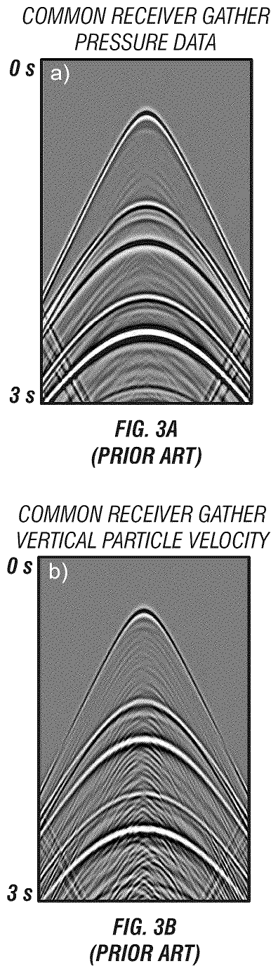

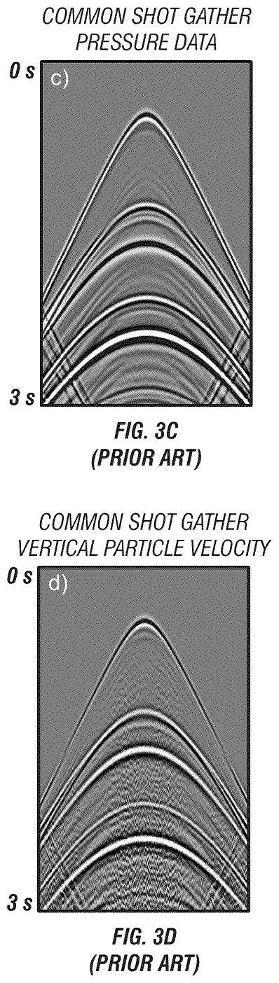

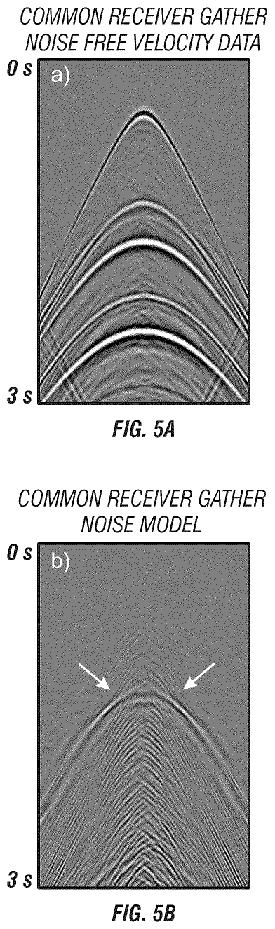

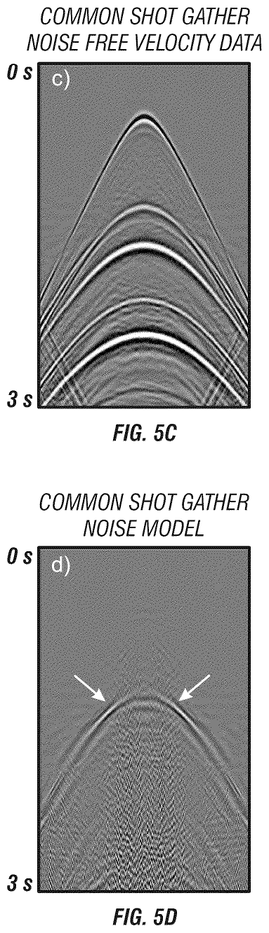

In a second example to demonstrate the performance of a method according to the present disclosure, one embodiment of such method has been applied to the synthetic seismic data shown in FIGS. 3A through 3D, which were created using a 2D elastic finite difference code (Thorbecke and Draganov, 2011). It may be observed that the Vz-noise is weak or absent on the hydrophone (pressure) data but is clearly present on the geophone (particle motion) data. The Vz noise exhibits expected characteristics, i.e., coherency in common-receiver gathers (FIG. 3B) and apparent incoherency in common-shot gathers (FIG. 3D). In the present example, the approach of Eq. (13) was applied to the modelled data in FIGS. 3A through 3D. The results are shown in FIG. 5A through 5D in both the common-shot domain and common-receiver domain. The noise model is recovered well although there is some weak leakage at ˜1.4 s (indicated by arrows) which is due to the first order water bottom multiple and a deeper reflection (z=1260 m) arriving at about the same time. As a result, destructive interference occurs in the hydrophone data, whereas constructive interference takes place in the geophone data. The leakage is mild, easily ameliorated and must be balanced against the efficacy of the noise estimated by the method according to the present disclosure. It is concluded that the present method can produce good estimates of the Vz-noise field.

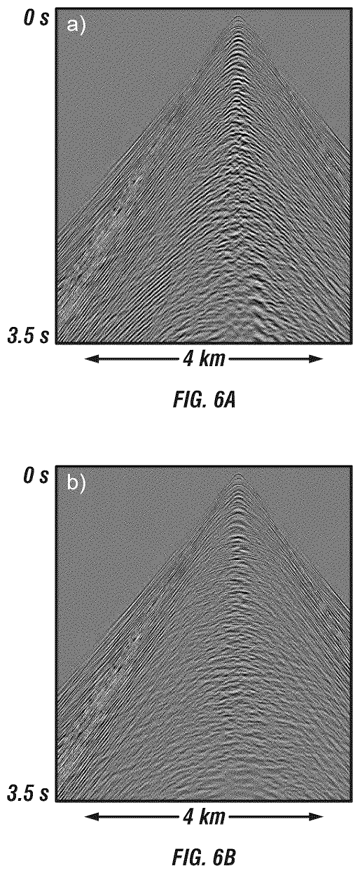

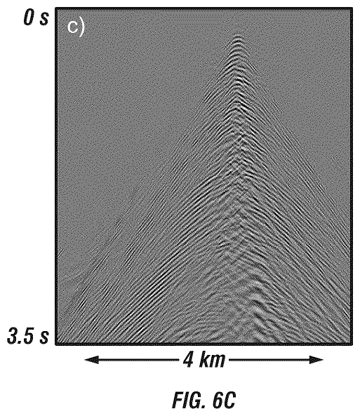

A third example using actual seismic data from the North Sea is shown in FIGS. 6A through 6C. FIG. 6A shows the input geophone data in the common-receiver domain containing a significant amount of Vz-noise. FIG. 6B and FIG. 6C show the denoised data and the estimated Vz-noise using the proposed approach. The Vz-noise has been very well estimated and removed from the geophone data. As a result, the particle velocity data is much more comparable in amplitude and character to the pressure data (not shown), which should be expected in order to perform effective wavefield separation.

In light of the principles and example embodiments described and illustrated herein, it will be recognized that the example embodiments can be modified in arrangement and detail without departing from such principles. The foregoing discussion has focused on specific embodiments, but other configurations are also contemplated. In particular, even though expressions such as in “an embodiment,” or the like are used herein, these phrases are meant to generally reference embodiment possibilities, and are not intended to limit the disclosure to particular embodiment configurations. As used herein, these terms may reference the same or different embodiments that are combinable into other embodiments. As a rule, any embodiment referenced herein is freely combinable with any one or more of the other embodiments referenced herein, and any number of features of different embodiments are combinable with one another, unless indicated otherwise. Although only one example has been described in detail above, those skilled in the art will readily appreciate that many modifications are possible within the scope of the described examples. Accordingly, all such modifications are intended to be included within the scope of this disclosure as defined in the following claims.

### REFERENCES CITED IN THIS DISCLOSURE

Goldstein, T., and Osher, S., 2008, The Split Bregman Method for L1-Regularized Problems, SIAM J. Imaging Sci. 2: 323-343. Retrieved 22 Apr. 2021.
Baron, D., Duarte, M. F., Wakin, M. B., Sarvotham, S. and Baraniuk, R. G., 2009, Distributed compressive sensing. arXiv preprint arXiv:0901.3403.
Oghenekohwo, F., Wason, H., Esser, E. and Herrmann, F. J., 2017, Low-cost time-lapse seismic with distributed compressive sensing—Part 1: Exploiting common information among the vintages. Geophysics, 82(3), P1-P13.
Tian, Y., Wei, L., Li, C., Oppert, S., and Hennenfent, G., 2018, Joint sparsity recovery for noise attenuation. SEG Technical Program Expanded Abstracts, 4186-4190.
Barr, F. J., and Sanders, J. I., 1989, Attenuation of water-column reverberations using pressure and velocity detectors in a water-bottom cable, SEG Technical Program Expanded Abstracts: 653-656.
Craft, K. L., and Paffenholz, J., 2007, Geophone noise attenuation and wavefield separation using a multidimensional decomposition technique. In SEG Technical Program Expanded Abstracts 2007 (pp. 2630-2634). Society of Exploration Geophysicists.
Craft, K. L., and Paffenholz, J., 2008, Geophone noise attenuation and wavefield separation using a multi-dimensional decomposition technique, Patent US20080221801A1
Hampson, G. and G. Szumski, 2020, Down/down deconvolution: 82nd Annual International Conference and Exhibition, EAGE, Extended Abstracts, El 04
Paffenholz, J., Docherty, P., Shurtleff, R. and Hays, D., 2006a, Shear Wave Noise on OBS Vz Data—Part II Elastic Modeling of Scatterers in the Seabed. In: 68th EAGE Conference and Exhibition incorporating SPE EUROPEC 2006. European Association of Geoscientists & Engineers, cp-2.
Paffenholz, J., Shurtleff, R., Hays, D. and Docherty, P., 2006b, Shear Wave Noise on OBS Vz Data-Part I Evidence from Field Data. In: 68th EAGE Conference and Exhibition incorporating SPE EUROPEC 2006. European Association of Geoscientists & Engineers, cp-2.

What is claimed is:

1. A method for estimating noise in particle motion seismic sensor recordings resulting from at least one of unwanted vibrations, turbulence in a water column and/or interface waves back-scattered from shallow heterogeneities, the method comprising:
sending as input to a computer seismic signals comprising pressure related signals and particle motion related signals detected at spaced apart locations with reference to position of a seismic energy source in a body of water partly in response to actuation of the seismic energy source and partly in response to noise comprising vibrations and turbulence;
in the computer, applying a sparsity promoting transformation to the input seismic signals;
in the computer, constructing a matrix Ã and column vector \tilde{b} according to the expression:
$$\tilde{A} = ( \begin{matrix}I & I & 0 \\ I & - I & λ I\end{matrix} ) \qquad \tilde{x} = ( \begin{matrix}d \\ u \\ n\end{matrix} ) \qquad \tilde{b} = ( \begin{matrix}{A}^{- 1} p \\ {A}^{- 1} z\end{matrix} ) ,$$
wherein d represents a down-going seismic wavefield, u represents an up-going seismic wavefield, n represents the noise and λ represents a user-chosen scalar to adjust emphasis of the noise;
in the computer, solving a constrained minimization according to the expression
$$\begin{matrix}\tilde{x} = arg min μ {‖ \tilde{x} ‖}_{1} + \frac{1}{2} {‖ \tilde{x} ‖}_{2}^{2} & s . t . & \tilde{A} \tilde{x}\end{matrix} = \tilde{b}$$
for \tilde{x}; wherein μ represents a user-chosen scalar to adjust relative importance of minimization norms;
in the computer, inverse transforming and reordering the solved constrained minimization back into a domain of the input seismic signals; and
in the computer, generating an output comprising an estimate of the noise in the particle motion related signals.

2. The method of claim 1 further comprising, in the computer, generating an output comprising up-going and down-going total wavefields.

3. The method of claim 1 wherein the sparsity promoting transformation comprises at least one of, a Fourier transform, a Radon transform, Wavefield extrapolation, Normal moveout correction, 1 dimensional filtering, 2 dimensional filtering, 3 dimensional filtering and wavelet transforming.

4. The method of claim 1 further comprising repeating the applying, constructing, solving, inverse transforming and generating an output in overlapping 1 dimensional, 2 dimensional or 3 dimensional windows.

5. The method of claim 1 wherein the sparsity promoting transform is based on one or more of the following functions: Activelet, AMlet, Armlet, Bandlet, Barlet, Bathlet, Beamlet, Binlet, Bumplet, Brushlet, Caplet, Camplet, Chirplet, Chordlet, Circlet, Coiflet, Contourlet, Cooklet, Craplet, Cubelet, CURElet, Curvelet, Daublet, Directionlet, Dreamlet, Edgelet, FAMlet, FLaglet, Flatlet, Fourierlet, Framelet, Fresnelet, Gaborlet, GAMlet, Gausslet, Graphlet, Grouplet, Haarlet, Haardlet, Heatlet, Hutlet, Hyperbolet, Icalet (Icalette), Interpolet, Loglet, Marrlet, MIMOlet, Monowavelet, Morelet, Morphlet, Multiselectivelet, Multiwavelet, Needlet, Noiselet, Ondelette, Ondulette, Prewavelet, Phaselet, Planelet, Platelet, Purelet, QVlet, Radonlet, RAMlet, Randlet, Ranklet, Ridgelet, Riezlet, Ripplet (original, type-I and II), Scalet, S2let, Seamlet, Seislet, Shadelet, Shapelet, Shearlet, Sinclet, Singlet, Slantlet, Smoothlet, Snakelet, SOHOlet, Sparselet, Spikelet, Splinelet, Starlet, Steerlet, Stockeslet, SURE-let (SURElet), Surfacelet, Surflet, Symmlet, S2let, Tetrolet, Treelet, Vaguelette, Wavelet-Vaguelette, Wavelet, Warblet, Warplet, Wedgelet, Xlet.

6. The method of claim 1 in which the matrix Ã and the column vectors \tilde{b} and \tilde{x} are populated according to definitions comprising
$$\tilde{A} = ( \begin{matrix}{A}_{0} & {A}_{1} & 0 \\ {A}_{2} & - {A}_{3} & λ {A}_{4}\end{matrix} ) \qquad \tilde{x} = ( \begin{matrix}d \\ u \\ n\end{matrix} ) \qquad \tilde{b} = ( \begin{matrix}p \\ z\end{matrix} ) ,$$
wherein A₁, A₂, A₃ and A₄ comprise inverse sparsity promoting transforms.

7. The method of claim 6 further comprising generating an output comprising up-going and down-going total wavefields.

8. The method of claim 6 wherein the sparsity promoting transformation comprises at least one of, a Fourier transform, a Radon transform, Wavefield extrapolation, Normal moveout correction, 1 dimensional filtering, 2 dimensional filtering, 3 dimensional filtering and wavelet transforming.

9. The method of claim 6 further comprising repeating the applying, constructing, solving inverse transforming and generating an output in overlapping 1 dimensional, 2 dimensional or 3 dimensional windows.

10. The method of claim 6 wherein the sparsity promoting transform is based on one or more of the following functions: Activelet, AMlet, Armlet, Bandlet, Barlet, Bathlet, Beamlet, Binlet, Bumplet, Brushlet, Caplet, Camplet, Chirplet, Chordlet, Circlet, Coiflet, Contourlet, Cooklet, Craplet, Cubelet, CURElet, Curvelet, Daublet, Directionlet, Dreamlet, Edgelet, FAMlet, FLaglet, Flatlet, Fourierlet, Framelet, Fresnelet, Gaborlet, GAMlet, Gausslet, Graphlet, Grouplet, Haarlet, Haardlet, Heatlet, Hutlet, Hyperbolet, Icalet (Icalette), Interpolet, Loglet, Marrlet, MIMOlet, Monowavelet, Morelet, Morphlet, Multiselectivelet, Multiwavelet, Needlet, Noiselet, Ondelette, Ondulette, Prewavelet, Phaselet, Planelet, Platelet, Purelet, QVlet, Radonlet, RAMlet, Randlet, Ranklet, Ridgelet, Riezlet, Ripplet (original, type-I and II), Scalet, S2let, Seamlet, Seislet, Shadelet, Shapelet, Shearlet, Sinclet, Singlet, Slantlet, Smoothlet, Snakelet, SOHOlet, Sparselet, Spikelet, Splinelet, Starlet, Steerlet, Stockeslet, SURE-let (SURElet), Surfacelet, Surflet, Symmlet, S2let, Tetrolet, Treelet, Vaguelette, Wavelet-Vaguelette, Wavelet, Warblet, Warplet, Wedgelet, Xlet.

11. The method of claim 1 wherein the detected particle motion signals are detected along a direction other than vertical and the estimated noise is along a direction co-linear with the detected direction.

12. The method of claim 11 wherein the co-linear direction comprises at least one forward-going (F), backward-going (B), right-going (R) and left-going (L) with reference to a direction of the spaced apart locations with reference to the seismic energy source.

13. The method of claim 1 wherein the spaced apart locations are on a bottom of the body of water.

14. A method for seismic surveying, comprising:
at selected times, actuating a seismic energy source in a body of water;
detecting seismic signals at a plurality of spaced apart locations in the body of water, the signals comprising pressure related signals and particle motion related partly in response to actuation of the seismic energy source and partly in response to noise comprising at least one of interface waves back-scattered from shallow heterogeneities, vibrations and/or turbulence;
conducting the detected signals to a computer;
in the computer, applying a sparsity promoting transformation to the input seismic signals;
in the computer, constructing a matrix Ã and column vector \tilde{b} according to the expression:
$$\tilde{A} = ( \begin{matrix}I & I & 0 \\ I & - I & λ I\end{matrix} ) \qquad \tilde{x} = ( \begin{matrix}d \\ u \\ n\end{matrix} ) \qquad \tilde{b} = ( \begin{matrix}{A}^{- 1} p \\ {A}^{- 1} z\end{matrix} ) ,$$
wherein d represents a down-going seismic wavefield, u represents an up-going seismic wavefield, n represents the noise and λ represents a user-chosen scalar to adjust emphasis of the noise;
in the computer, solving a constrained minimization according to the expression
$$\begin{matrix}\tilde{x} = arg min μ {‖ \tilde{x} ‖}_{1} + \frac{1}{2} {‖ \tilde{x} ‖}_{2}^{2} & s . t . & \tilde{A} \tilde{x}\end{matrix} = \tilde{b}$$
for \tilde{x}; wherein μ represents a user-chosen scalar to adjust relative importance of minimization norms;
in the computer, inverse transforming and reordering the solved constrained minimization back into a domain of the input seismic signals; and
in the computer, generating an output comprising an estimate of the noise in the particle motion related signals.

15. The method of claim 14 further comprising, in the computer, generating an output comprising up-going and down-going total wavefields.

16. The method of claim 14 wherein the sparsity promoting transformation comprises at least one of, a Fourier transform, a Radon transform, Wavefield extrapolation, Normal moveout correction, 1 dimensional filtering, 2 dimensional filtering, 3 dimensional filtering and wavelet transforming.

17. The method of claim 14 further comprising repeating the applying, constructing, solving, inverse transforming and generating an output in overlapping 1 dimensional, 2 dimensional or 3 dimensional windows.

18. The method of claim 14 wherein the sparsity promoting transform is based on one or more of the following functions: Activelet, AMlet, Armlet, Bandlet, Barlet, Bathlet, Beamlet, Binlet, Bumplet, Brushlet, Caplet, Camplet, Chirplet, Chordlet, Circlet, Coiflet, Contourlet, Cooklet, Craplet, Cubelet, CURElet, Curvelet, Daublet, Directionlet, Dreamlet, Edgelet, FAMlet, FLaglet, Flatlet, Fourierlet, Framelet, Fresnelet, Gaborlet, GAMlet, Gausslet, Graphlet, Grouplet, Haarlet, Haardlet, Heatlet, Hutlet, Hyperbolet, Icalet (Icalette), Interpolet, Loglet, Marrlet, MIMOlet, Monowavelet, Morelet, Morphlet, Multiselectivelet, Multiwavelet, Needlet, Noiselet, Ondelette, Ondulette, Prewavelet, Phaselet, Planelet, Platelet, Purelet, QVlet, Radonlet, RAMlet, Randlet, Ranklet, Ridgelet, Riezlet, Ripplet (original, type-I and II), Scalet, S2let, Seamlet, Seislet, Shadelet, Shapelet, Shearlet, Sinclet, Singlet, Slantlet, Smoothlet, Snakelet, SOHOlet, Sparselet, Spikelet, Splinelet, Starlet, Steerlet, Stockeslet, SURE-let (SURElet), Surfacelet, Surflet, Symmlet, S2let, Tetrolet, Treelet, Vaguelette, Wavelet-Vaguelette, Wavelet, Warblet, Warplet, Wedgelet, Xlet.

19. The method of claim 14 in which the matrix Ã and the column vectors \tilde{b} and \tilde{x} are populated according to definitions comprising
$$\tilde{A} = ( \begin{matrix}{A}_{0} & {A}_{1} & 0 \\ {A}_{2} & - {A}_{3} & λ {A}_{4}\end{matrix} ) \qquad \tilde{x} = ( \begin{matrix}d \\ u \\ n\end{matrix} ) \qquad \tilde{b} = ( \begin{matrix}p \\ z\end{matrix} ) ,$$
wherein A₁, A₂, A₃ and A₄ comprise inverse sparsity promoting transforms.

20. The method of claim 19 further comprising generating an output comprising up-going and down-going total wavefields.

21. The method of claim 19 wherein the sparsity promoting transformation comprises at least one of, a Fourier transform, a Radon transform, Wavefield extrapolation, Normal moveout correction, 1 dimensional filtering, 2 dimensional filtering, 3 dimensional filtering and wavelet transforming.

22. The method of claim 19 further comprising repeating the applying, constructing, solving inverse transforming and generating an output in overlapping 1 dimensional, 2 dimensional or 3 dimensional windows.

23. The method of claim 19 wherein the sparsity promoting transform is based on one or more of the following functions: Activelet, AMlet, Armlet, Bandlet, Barlet, Bathlet, Beamlet, Binlet, Bumplet, Brushlet, Caplet, Camplet, Chirplet, Chordlet, Circlet, Coiflet, Contourlet, Cooklet, Craplet, Cubelet, CURElet, Curvelet, Daublet, Directionlet, Dreamlet, Edgelet, FAMlet, FLaglet, Flatlet, Fourierlet, Framelet, Fresnelet, Gaborlet, GAMlet, Gausslet, Graphlet, Grouplet, Haarlet, Haardlet, Heatlet, Hutlet, Hyperbolet, Icalet (Icalette), Interpolet, Loglet, Marrlet, MIMOlet, Monowavelet, Morelet, Morphlet, Multiselectivelet, Multiwavelet, Needlet, Noiselet, Ondelette, Ondulette, Prewavelet, Phaselet, Planelet, Platelet, Purelet, QVlet, Radonlet, RAMlet, Randlet, Ranklet, Ridgelet, Riezlet, Ripplet (original, type-I and II), Scalet, S2let, Seamlet, Seislet, Shadelet, Shapelet, Shearlet, Sinclet, Singlet, Slantlet, Smoothlet, Snakelet, SOHOlet, Sparselet, Spikelet, Splinelet, Starlet, Steerlet, Stockeslet, SURE-let (SURElet), Surfacelet, Surflet, Symmlet, S2let, Tetrolet, Treelet, Vaguelette, Wavelet-Vaguelette, Wavelet, Warblet, Warplet, Wedgelet, Xlet.

24. The method of claim 14 wherein the detected particle motion signals are detected along a direction other than vertical and the estimated noise is along a direction co-linear with the detected direction.

25. The method of claim 24 wherein the co-linear direction comprises at least one forward-going (F), backward-going (B), right-going (R) and left-going (L) with reference to a direction of the spaced apart locations with reference to the seismic energy source.

26. The method of claim 14 wherein the spaced apart locations are on a bottom of the body of water.

27. A method for estimating noise in particle motion seismic sensor recordings resulting from interface waves back-scattered from shallow heterogeneities, the method comprising:
sending as input to a computer seismic signals comprising pressure related signals and particle motion related signals detected on a bottom of a body of water in response to actuation of a seismic energy source;
in the computer, applying a sparsity promoting transformation to the input seismic signals;
in the computer, constructing a matrix Ã and column vector \tilde{b} according to the expression:
$$\tilde{A} = ( \begin{matrix}I & I & 0 \\ I & - I & λ I\end{matrix} ) \qquad \tilde{x} = ( \begin{matrix}d \\ u \\ n\end{matrix} ) \qquad \tilde{b} = ( \begin{matrix}{A}^{- 1} p \\ {A}^{- 1} z\end{matrix} ) ,$$
wherein d represents a down-going seismic wavefield, u represents an up-going seismic wavefield, n represents the noise and λ represents a user-chosen scalar to adjust emphasis of the noise;
in the computer, solving a constrained minimization according to the expression
$$\begin{matrix}\tilde{x} = arg min μ {‖ \tilde{x} ‖}_{1} + \frac{1}{2} {‖ \tilde{x} ‖}_{2}^{2} & s . t . & \tilde{A} \tilde{x}\end{matrix} = \begin{matrix}\tilde{b} & for \tilde{x}\end{matrix} ;$$
wherein μ represents a user-chosen scalar to adjust relative importance of minimization norms;
in the computer, inverse transforming and reordering the solved constrained minimization back into a domain of the input seismic signals; and
in the computer, generating an output comprising an estimate of the noise in the particle motion related signals resulting from the interface waves.

28. The method of claim 27 further comprising, in the computer, generating an output comprising up-going and down-going total wavefields.

29. The method of claim 27 wherein the sparsity promoting transformation comprises at least one of, a Fourier transform, a Radon transform, Wavefield extrapolation, Normal moveout correction, 1 dimensional filtering, 2 dimensional filtering, 3 dimensional filtering and wavelet transforming.

30. The method of claim 27 further comprising repeating the applying, constructing, solving inverse transforming and generating an output in overlapping 1 dimensional, 2 dimensional or 3 dimensional windows.

31. The method of claim 27 wherein the sparsity promoting transform is based on one or more of the following functions: Activelet, AMlet, Armlet, Bandlet, Barlet, Bathlet, Beamlet, Binlet, Bumplet, Brushlet, Caplet, Camplet, Chirplet, Chordlet, Circlet, Coiflet, Contourlet, Cooklet, Craplet, Cubelet, CURElet, Curvelet, Daublet, Directionlet, Dreamlet, Edgelet, FAMlet, FLaglet, Flatlet, Fourierlet, Framelet, Fresnelet, Gaborlet, GAMlet, Gausslet, Graphlet, Grouplet, Haarlet, Haardlet, Heatlet, Hutlet, Hyperbolet, Icalet (Icalette), Interpolet, Loglet, Marrlet, MIMOlet, Monowavelet, Morelet, Morphlet, Multiselectivelet, Multiwavelet, Needlet, Noiselet, Ondelette, Ondulette, Prewavelet, Phaselet, Planelet, Platelet, Purelet, QVlet, Radonlet, RAMlet, Randlet, Ranklet, Ridgelet, Riezlet, Ripplet (original, type-I and II), Scalet, S2let, Seamlet, Seislet, Shadelet, Shapelet, Shearlet, Sinclet, Singlet, Slantlet, Smoothlet, Snakelet, SOHOlet, Sparselet, Spikelet, Splinelet, Starlet, Steerlet, Stockeslet, SURE-let (SURElet), Surfacelet, Surflet, Symmlet, S2let, Tetrolet, Treelet, Vaguelette, Wavelet-Vaguelette, Wavelet, Warblet, Warplet, Wedgelet, Xlet.

32. The method of claim 27 in which matrix Ã and column vectors \tilde{b} and \tilde{x} are populated according to definitions comprising
$$\tilde{A} = ( \begin{matrix}{A}_{0} & {A}_{1} & 0 \\ {A}_{2} & - {A}_{3} & λ {A}_{4}\end{matrix} ) \qquad \tilde{x} = ( \begin{matrix}d \\ u \\ n\end{matrix} ) \qquad \tilde{b} = ( \begin{matrix}p \\ z\end{matrix} )$$
wherein A₁, A₂, A₃ and A₄ comprise sparsity promoting transforms.

33. The method of claim 32 further comprising generating an output comprising up-going and down-going total wavefields.

34. The method of claim 32 wherein the sparsity promoting transformation comprises at least one of, a Fourier transform, a Radon transform, Wavefield extrapolation, Normal moveout correction, 1 dimensional filtering, 2 dimensional filtering, 3 dimensional filtering and wavelet transforming.

35. The method of claim 32 further comprising repeating the applying, constructing, solving inverse transforming and generating an output in overlapping 1 dimensional, 2 dimensional or 3 dimensional windows.

36. The method of claim 32 wherein the sparsity promoting transform is based on one or more of the following functions: Activelet, AMlet, Armlet, Bandlet, Barlet, Bathlet, Beamlet, Binlet, Bumplet, Brushlet, Caplet, Camplet, Chirplet, Chordlet, Circlet, Coiflet, Contourlet, Cooklet, Craplet, Cubelet, CURElet, Curvelet, Daublet, Fresnelet, Gaborlet, GAMlet, Gausslet, Graphlet, Grouplet, Haarlet, Haardlet, Heatlet, Hutlet, Hyperbolet, Icalet (Icalette), Interpolet, Loglet, Marrlet, MIMOlet, Monowavelet, Morelet, Morphlet, Multiselectivelet, Multiwavelet, Needlet, Noiselet, Ondelette, Ondulette, Prewavelet, Phaselet, Planelet, Platelet, Purelet, QVlet, Radonlet, RAMlet, Randlet, Ranklet, Ridgelet, Riezlet, Ripplet (original, type-I and II), Scalet, S2let, Seamlet, Seislet, Shadelet, Shapelet, Shearlet, Sinclet, Singlet, Slantlet, Smoothlet, Snakelet, SOHOlet, Sparselet, Spikelet, Splinelet, Starlet, Steerlet, Stockeslet, SURE-let (SURElet), Surfacelet, Surflet, Symmlet, S2let, Tetrolet, Treelet, Vaguelette, Wavelet-Vaguelette, Wavelet, Warblet, Warplet, Wedgelet, Xlet.

37. A computer program stored in a non-transitory computer readable medium, the program comprising logic operable to cause a programmable computer to perform actions comprising:
accepting as input to the computer seismic signals comprising pressure related signals and particle motion related signals detected at spaced apart locations with reference to position of a seismic energy source in a body of water partly in response to actuation of the seismic energy source and partly in response to noise comprising vibrations and turbulence;
applying a sparsity promoting transformation to the input seismic signals;
constructing a matrix Ã and column vector \tilde{b} according to the expression,
$$\tilde{A} = ( \begin{matrix}I & I & 0 \\ I & - I & λ I\end{matrix} ) \qquad \tilde{x} = ( \begin{matrix}d \\ u \\ n\end{matrix} ) \qquad \tilde{b} = ( \begin{matrix}{A}^{- 1} p \\ {A}^{- 1} z\end{matrix} ) ,$$
wherein d represents a down-going seismic wavefield, u represents an up-going seismic wavefield, n represents the noise and λ represents a user-chosen scalar to adjust emphasis of the noise;
solving a constrained minimization according to the expression
$$\begin{matrix}\tilde{x} = arg min μ {‖ \tilde{x} ‖}_{1} + \frac{1}{2} {‖ \tilde{x} ‖}_{2}^{2} & s . t . & \tilde{A} \tilde{x}\end{matrix} = \tilde{b}$$
for \tilde{x}; wherein μ represents a user-chosen scalar to adjust relative importance of minimization norms;
inverse transforming and reordering the solved constrained minimization back into a domain of the input seismic signals; and
generating an output comprising an estimate of the noise in the particle motion related signals.

38. The computer program of claim 37 further comprising, in the computer, generating an output comprising up-going and down-going total wavefields.

39. The computer program of claim 37 wherein the sparsity promoting transformation comprises at least one of, a Fourier transform, a Radon transform, Wavefield extrapolation, Normal moveout correction, 1 dimensional filtering, 2 dimensional filtering, 3 dimensional filtering and wavelet transforming.

40. The computer program of claim 37 further comprising repeating the applying, constructing, solving, inverse transforming and generating an output in overlapping 1 dimensional, 2 dimensional or 3 dimensional windows.

41. The computer program of claim 37 wherein the sparsity promoting transform is based on one or more of the following functions: Activelet, AMlet, Armlet, Bandlet, Barlet, Bathlet, Beamlet, Binlet, Bumplet, Brushlet, Caplet, Camplet, Chirplet, Chordlet, Circlet, Coiflet, Contourlet, Cooklet, Craplet, Cubelet, CURElet, Curvelet, Daublet, Directionlet, Dreamlet, Edgelet, FAMlet, FLaglet, Flatlet, Fourierlet, Framelet, Fresnelet, Gaborlet, GAMlet, Gausslet, Graphlet, Grouplet, Haarlet, Haardlet, Heatlet, Hutlet, Hyperbolet, Icalet (Icalette), Interpolet, Loglet, Marrlet, MIMOlet, Monowavelet, Morelet, Morphlet, Multiselectivelet, Multiwavelet, Needlet, Noiselet, Ondelette, Ondulette, Prewavelet, Phaselet, Planelet, Platelet, Purelet, QVlet, Radonlet, RAMlet, Randlet, Ranklet, Ridgelet, Riezlet, Ripplet (original, type-I and II), Scalet, S2let, Seamlet, Seislet, Shadelet, Shapelet, Shearlet, Sinclet, Singlet, Slantlet, Smoothlet, Snakelet, SOHOlet, Sparselet, Spikelet, Splinelet, Starlet, Steerlet, Stockeslet, SURE-let (SURElet), Surfacelet, Surflet, Symmlet, S2let, Tetrolet, Treelet, Vaguelette, Wavelet-Vaguelette, Wavelet, Warblet, Warplet, Wedgelet, Xlet.

42. The computer program of claim 37 in which the matrix Ã and the column vectors \tilde{b} and \tilde{x} are populated according to definitions comprising
$$\tilde{A} = ( \begin{matrix}{A}_{0} & {A}_{1} & 0 \\ {A}_{2} & - {A}_{3} & λ {A}_{4}\end{matrix} ) \qquad \tilde{x} = ( \begin{matrix}d \\ u \\ n\end{matrix} ) \qquad \tilde{b} = ( \begin{matrix}p \\ z\end{matrix} ) ,$$
wherein A₁, A₂, A₃ and A₄ comprise inverse sparsity promoting transforms.

43. The computer program of claim 42 further comprising generating an output comprising up-going and down-going total wavefields.

44. The computer program of claim 42 wherein the sparsity promoting transformation comprises at least one of, a Fourier transform, a Radon transform, Wavefield extrapolation, Normal moveout correction, 1 dimensional filtering, 2 dimensional filtering, 3 dimensional filtering and wavelet transforming.

45. The computer program of claim 42 further comprising repeating the applying, constructing, solving inverse transforming and generating an output in overlapping 1 dimensional, 2 dimensional or 3 dimensional windows.

46. The computer program of claim 42 wherein the sparsity promoting transform is based on one or more of the following functions: Activelet, AMlet, Armlet, Bandlet, Barlet, Bathlet, Beamlet, Binlet, Bumplet, Brushlet, Caplet, Camplet, Chirplet, Chordlet, Circlet, Coiflet, Contourlet, Cooklet, Craplet, Cubelet, CURElet, Curvelet, Daublet, Directionlet, Dreamlet, Edgelet, FAMlet, FLaglet, Flatlet, Fourierlet, Framelet, Fresnelet, Gaborlet, GAMlet, Gausslet, Graphlet, Grouplet, Haarlet, Haardlet, Heatlet, Hutlet, Hyperbolet, Icalet (Icalette), Interpolet, Loglet, Marrlet, MIMOlet, Monowavelet, Morelet, Morphlet, Multiselectivelet, Multiwavelet, Needlet, Noiselet, Ondelette, Ondulette, Prewavelet, Phaselet, Planelet, Platelet, Purelet, QVlet, Radonlet, RAMlet, Randlet, Ranklet, Ridgelet, Riezlet, Ripplet (original, type-I and II), Scalet, S2let, Seamlet, Seislet, Shadelet, Shapelet, Shearlet, Sinclet, Singlet, Slantlet, Smoothlet, Snakelet, SOHOlet, Sparselet, Spikelet, Splinelet, Starlet, Steerlet, Stockeslet, SURE-let (SURElet), Surfacelet, Surflet, Symmlet, S2let, Tetrolet, Treelet, Vaguelette, Wavelet-Vaguelette, Wavelet, Warblet, Warplet, Wedgelet, Xlet.

47. The computer program of claim 42 wherein the detected particle motion signals are detected along a direction other than vertical and the estimated noise is along a direction co-linear with the detected direction.

48. The computer program of claim 47 wherein the co-linear direction comprises at least one forward-going (F), backward-going (B), right-going (R) and left-going (L) with reference to a direction of the spaced apart locations with reference to the seismic energy source.

49. The computer program of claim 37 wherein the spaced apart locations are on a bottom of the body of water.
